(19) United States
(12) Patent Application Publication
(10) Pub. No.: US 2010/0300164 A1
(43) Pub. Date: Dec. 2, 2010

(54) Wafer-type Tumbler Cylinder

(76) Inventor: Cheng-Ju YANG, Taipei (TW)

Correspondence Address: Elaine Pan, P. O. Box 1-252, Sanchung, 241, omitted

(21) Appl. No.: 12/716,367

(22) Filed: Mar. 3, 2010

(30) Foreign Application Priority Data
May 27, 2009 (TW) 098209351

(51) Int. Cl. E05B 29/00; E05B 15/14

(52) U.S. Cl. 70/377

(57) ABSTRACT

A wafer-type tumbler cylinder comprises a sleeve, a cylinder, some wafers, some springs, some riveting plates and some U-shaped fixtures. The wafer-type tumbler cylinder is an integral cylindrical shaft having U-shaped indentations and riveting plates made in a consistent operation. After the placement of every two wafers and one shared spring into the cylindrical shaft, the riveting plates are pressed into a horizontal position to secure the wafers spring; furthermore, all the riveting plates are installed on the left or right side, or on both sides. The improved structure of riveting plates and shared spring for every two wafers enables the key to move forward and backward smoothly, and also enables the users to lock and unlock easily and successfully.

### CROSS-REFERENCE TO RELATED APPLICATIONS

This application is a Continuation-in-Part of U.S. Pat. No. 7,530,246 on May 12, 2009, which is a Continuation of European Patent Application No. EP07108691.2 filed on May 22, 2007 (European Publication Number 1995401.) This application claims the benefit of and priority to Taiwanese Utility Model Application No. 098209351 filed on May 27, 2009.

### BACKGROUND OF THE INVENTION

1) Field of the Invention

The invention relates to a wafer-type tumbler cylinder, a cylindrical shaft and riveting plates of which are made in a consistent integrated operation, thereby facilitating the placement of wafers and springs and, furthermore, one spring serves as a shared spring for every two wafers. In addition to reducing the material cost of the spring, the riveting plates are installed on either left or right side of the cylindrical shaft or installed on both sides thereof. The improved structure of riveting plates and shared spring for every two wafers enables the key to move forward and backward smoothly, and also enables the users to lock and unlock easily and successfully.

2) Description of the Prior Art

A conventional wafer-type tumbler cylinder, as shown in FIG. 5, mainly comprises a sleeve 1a, a cylinder 2a, some wafers 3a and some springs 4a. The sleeve 1a has a bore 11a extending through it lengthwise; the cylinder 2a has a flange 22 and a drive section 23 at the front and rear ends; the cylinder 2a is a cylindrical shaft 20a with several diametrically rectangular through-holes 24a and, furthermore, at the two sides of each rectangular through-hole 24a is a C-shaped recess 25 and a horizontally oriented U-shaped recess 26 (as shown in FIGS. 6 and 7), for the installation of wafer 3a and spring 4a sets. Each wafer 3a of the conventional wafer-type tumbler cylinder, in addition to a window 31 in the middle of each wafer body 30, has an opposing spring tab 32 and a locating tab 34; when the wafer 3a is inserted into each rectangular through-hole 24a on the shaft 20a of the cylinder 2a, it is first necessary to install a spring 4a into the C-shaped recess 25 at one side of the rectangular through-hole 24a, following which the wafer 3a is then inserted into the rectangular through-hole 24a; but during the installation, since the wafer body 30 of the wafer 3a has the spring tab 32, its insertion occurs without any resistance along the C-shaped recess 25; however, the locating tab 34, disposed in the other side of the wafer body 30, must similarly undergo insertion through the C-shaped recess 25 along the rectangular through-hole 24a, and, as a result, friction occurs along the interior wall of the rectangular through-hole 24a at the opposite lateral of the C-shaped recess 25, and only after this does the locating tab 34 of the wafer body 30 reach into the horizontally oriented U-shaped recess 26, where it becomes nested onto the bottom of the horizontally oriented U-shaped recess 26 (as indicated in FIGS. 6 and 7), and also only then is the cylinder 2a installed in the bore 11a of the sleeve 1a, which completes the assembly of one wafer-type tumbler mechanism. As such, during the insertion of each wafer 3a into the rectangular through-hole 24a on the shaft 20a, the operation is difficult and adversely affects the production process. After each wafer 3a has been inserted into the rectangular through-hole 24a, the locating tab 34 on the wafer body 30 is nested onto the bottom of the horizontally oriented U-shaped recesses 26; however, the height of the locating tab 34 is quite limited and, furthermore, the locating tab 34 is subjected to the outwardly exerted elastic force of the spring 4a, thus the wafer 3a is often ejected out of the rectangular through-hole 24a. Such situation results in a troublesome and inconvenient assembly operation as the cylinder 2a is inserted into the bore 11a of the sleeve 1a, which likewise adversely affects the production process.

In view of such inconveniences and shortcomings during the process of production and assembly operation for the conventional wafer-type tumbler cylinder, the inventor filed a patent application entitled “Wafer-type tumbler cylinder and key” that has been issued as U.S. Pat. No. 7,530,246 B2 on May 12, 2009. The above-mentioned patent not only provides a cylinder for better placement of wafers and springs, but also provides a cylinder with a corrugated-contour keyway having a structure of one shared spring for every two wafers, thereby preventing theft by means of a metal sheet or other equivalent tool inserted for burglarizing. Even though such patent provides a better invention of wafer-type tumbler cylinder and key and many users have good opinions, the inventor still continues to conduct research and development on wafer-type tumbler cylinder and thus results in this improved wafer-type tumbler cylinder with riveting plates and better cylindrical shaft made in a consistent integrated operation.

### SUMMARY OF THE INVENTION

The objective of the invention herein is to provide a wafer-type tumbler cylinder having a cylindrical shaft and riveting plates made in a consistent operation. After the placement of every two wafers and one shared spring, the riveting plates are pressed into a horizontal position to secure the wafers and spring; furthermore, a U-shaped fixture is riveted in the middle of a U-shaped indentation such that the assembly of improved wafer-type tumbler cylinder is complete and the assembly cost is reduced as well. The improved invention enables the key to move forward and backward smoothly, and also enables the users to lock and unlock easily and successfully.

To achieve the objective of the invention herein, the shaft of the cylinder and riveting plates are made in a consistent operation into an integral cylindrical shaft wherein all the riveting plates are installed on the left side or all of them are installed on the right side or the riveting plates are installed on both sides of the cylindrical shaft. Then every two wafers and one shared spring are placed into the cylindrical shaft and each of the riveting plates is pressed into a horizontal position to firmly secure the wafers and spring therein. A U-shaped fixture is riveted in the middle of a U-shaped indentation respectively so that the assembly of improved wafer-type tumbler cylinder is finished and such improved structure enables the key to move forward and backward more smoothly, and also enables the users to lock and unlock more easily. Besides, it's able to prevent from prying effectively because a burglar can not pry two wafers supported by a shared spring with a metal plate or other equivalent tool.

### BRIEF DESCRIPTION OF THE DRAWINGS

FIG. 1 is an isometric drawing of the wafer-type tumbler cylinder in the present invention.

FIG. 2 is an exploded drawing of the wafer-type tumbler cylinder in the present invention.

FIG. 2-1 is an isometric drawing of the present wafer-type tumbler cylinder, riveting plates and the cylindrical shaft of which are made on both left and right sides thereof in a consistent operation. The riveting plates are raised when the placement of every two wafers and one shared spring are not executed.

FIG. 3 is an isometric drawing of the present wafer-type tumbler cylinder, riveting plates of which are made on either left or right side thereof in a consistent operation.

FIG. 3-1 is a vertically sectional view, as viewed from a perspective in FIG. 3.

FIG. 4 is an isometric drawing of the present wafer-type tumbler cylinder, riveting plates of which are made on both left and right sides thereof in a consistent operation.

FIG. 4-1 is a vertically sectional view, as viewed from a perspective in FIG. 4.

FIG. 5 is an exploded drawing of the conventional wafer-type tumbler cylinder.

FIG. 6 is a cross-sectional drawing of the conventional wafer-type tumbler installed with a wafer and a spring.

FIG. 7 is a cross-sectional drawing of the conventional wafer-type tumbler installed with another wafer and spring adjacent to the wafer and spring, as viewed from a perspective in FIG. 6

### DETAILED DESCRIPTION OF THE PREFERRED EMBODIMENTS

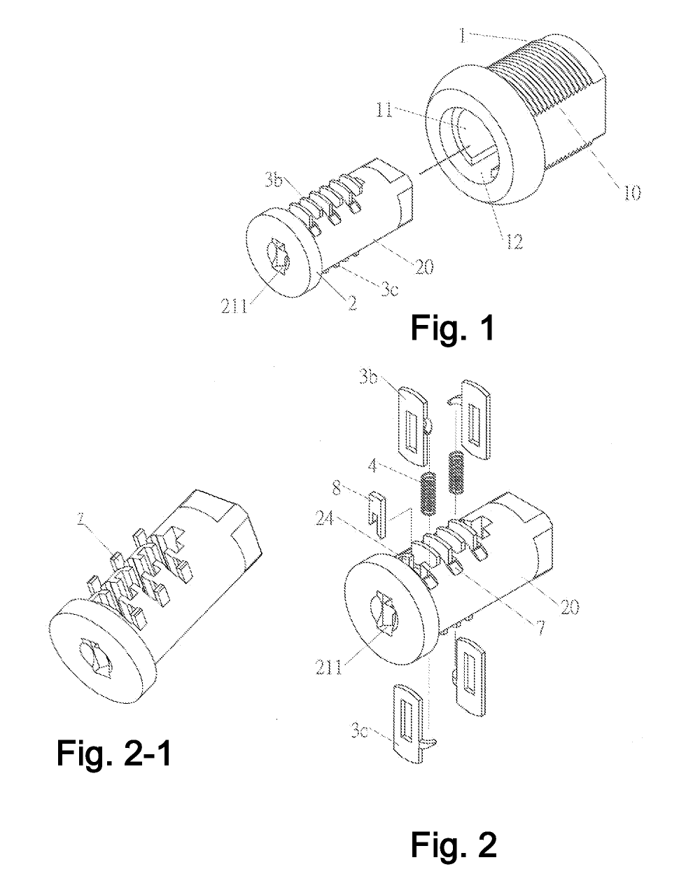

FIGS. 1 and 2 are isometric and exploded drawings of the wafer-type tumbler cylinder in the present invention. A wafer-type tumbler cylinder of the invention herein includes a sleeve 1, a cylinder 2, a plurality of wafers 3b, 3c, a plurality of springs 4, a plurality of riveting plates 7 and a plurality of U-shaped fixtures 8. The structure of the sleeve 1 and the method for installing with the cylinder 2 are the same as those of said conventional wafer-type tumbler. There is no need to go into details.

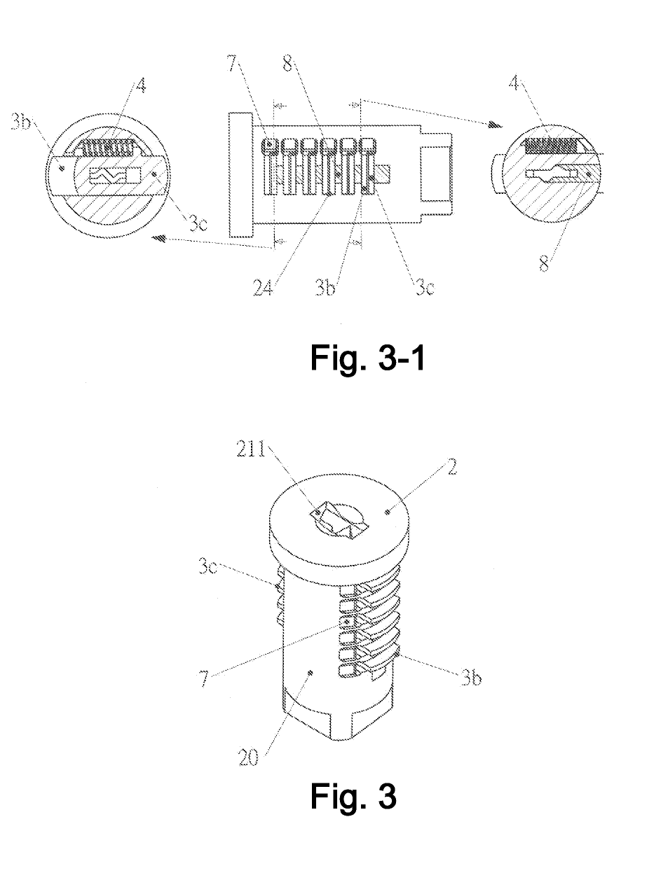

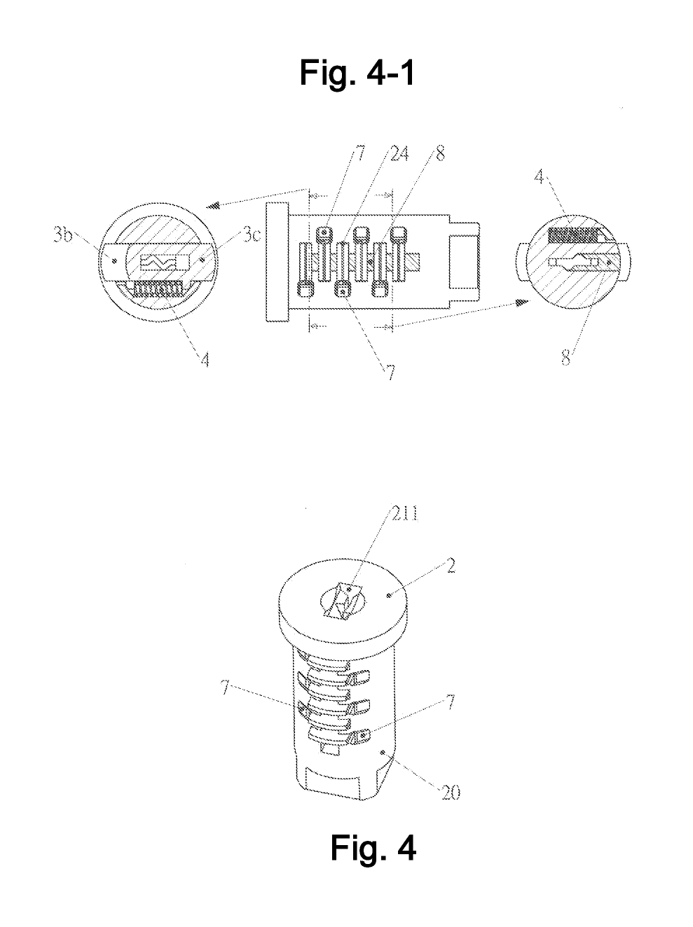

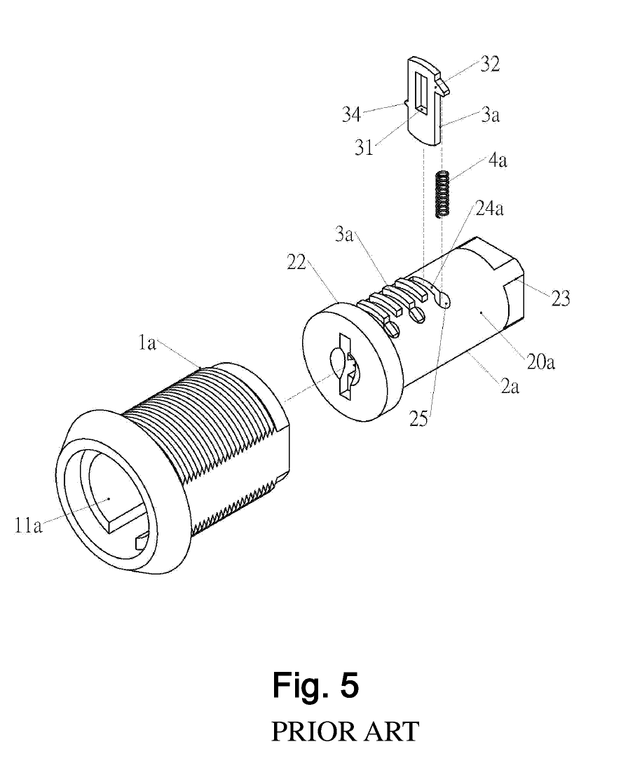

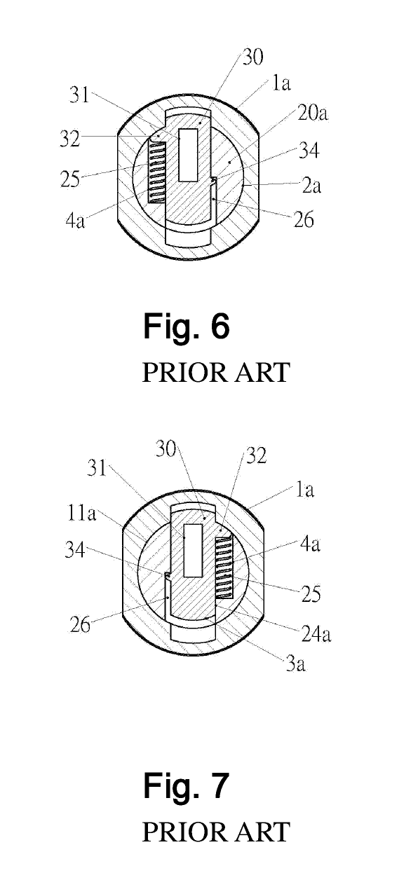

Please refer to FIG. 3, FIG. 3-1, FIG. 4 and FIG. 4-1 for isometric drawings and vertically sectional views of the present invention, the riveting plates and an integral cylindrical shaft of which are made in a consistent operation. The wafer-type tumbler cylinder of the invention is an integral cylindrical shaft 20 having U-shaped indentations 24 and riveting plates 7 made in a consistent operation (as shown in FIG. 2-1) and the riveting plates 7 are disposed at the positions corresponding to the shared spring 4 for every two wafers 3b, 3c respectively. All the riveting plates 7 are installed on the left side or all of them are installed on the right side, as shown in FIGS. 3 and 3-1; also, the riveting plates 7 are installed on both left and right sides of the cylindrical shaft 20, as illustrated in FIGS. 4 and 4-1.

After each of the wafers 3b, 3c and each shared spring 4 are placed into the integral cylindrical shaft 20, each of the riveting plates 7 is pressed into a horizontal position to firmly secure the wafers 3b, 3c and spring 4 in the cylindrical shaft 20; a U-shaped fixture 8 is riveted in the middle of the U-shaped indentation 24 respectively so that the assembly of improved wafer-type tumbler cylinder 2 is finished and such improved structure enables the key to move forward and backward more smoothly, and also enables the users to lock and unlock more easily. Besides, it's able to prevent from prying effectively because a burglar can not pry two wafers supported by a shared spring with a metal plate or other equivalent tool.

What is claimed is:

1. A wafer-type tumbler cylinder comprising a sleeve, a cylinder, a plurality of wafers, a plurality of springs, a plurality of riveting plates and a plurality of U-shaped fixtures, the cylinder being an cylindrical shaft having U-shaped indentations for the placement of one spring and two wafers, wherein the riveting plates are disposed in the positions corresponding to the spring for two wafers and each of the U-shaped fixtures is disposed in the middle of the U-shaped indentations; wherein the riveting plates and the cylindrical shaft of the cylinder are made in a consistent operation, the riveting plates of which are disposed on the left or right side, or on both left and right sides; wherein each of the springs and every two of the wafers are placed into the cylindrical shaft of the cylinder, and then the riveting plates are pressed into a horizontal position and the U-shaped fixtures are riveted in the middle of the U-shaped indentations respectively, thereby completing the assembly of the cylinder.
